(19) United States
(12) Patent Application Publication
(10) Pub. No.: US 2022/0165298 A1
(43) Pub. Date: May 26, 2022

(54) ELECTRONIC APPARATUS AND CONTROL METHOD THEREOF

(71) Applicant: SAMSUNG ELECTRONICS CO., LTD., Suwon-si (KR)

(72) Inventors: Gaeul Kim, Suwon-si (KR); Chanhee Choi, Suwon-si (KR)

(73) Assignee: SAMSUNG ELECTRONICS CO., LTD., Suwon-si (KR)

(21) Appl. No.: 17/566,347

(22) Filed: Dec. 30, 2021

Related U.S. Application Data
(63) Continuation of application No. PCT/KR2021/014693, filed on Oct. 20, 2021.

(30) Foreign Application Priority Data
Nov. 24, 2020 (KR) 10-2020-0158904

(51) Int. Cl. G10L 25/87; G10L 25/51; G06F 3/16

(52) U.S. Cl. CPC G10L 25/87; G06F 3/16; G10L 25/51

(57) ABSTRACT

An electronic apparatus includes a processor configured to: identify a noise characteristic based on a first audio signal received through a microphone, identify whether a second audio signal received through the microphone has a predetermined similarity level to a trigger command based on reference data, the reference data being selected from among pieces of reference data having a plurality of noise characteristics, respectively, and the selected reference data having a noise characteristic corresponding to the identified noise characteristic, and perform an operation corresponding to a user speech input based on a third audio signal received after the second audio signal having the predetermined similarity level.

### CROSS-REFERENCE TO RELATED APPLICATIONS

This application is a bypass continuation application of International Application No. PCT/KR2021/014693 filed on Oct. 20, 2021, which claims priority to Korean Patent Application No. 10-2020-0158904, filed on Nov. 24, 2020, in the Korean Intellectual Property Office, the disclosures of which are incorporated herein in their entireties by reference.

### BACKGROUND

### 1. Field

The disclosure relates to an electronic apparatus and a control method thereof, and more particularly to an electronic apparatus, which employs reference data whether a received audio signal matches to a trigger command, and a method of controlling the same.

### 2. Description of Related Art

An electronic apparatus may activate a speech recognition function based on recognition of a trigger command. The trigger command refers to a specific command for activating the speech recognition function. When it is identified that a received audio signal matches the trigger command, the speech recognition function is activated to apply speech recognition processing to a subsequently received user voice input, thereby performing an operation based on a recognition result.

However, when the trigger command is recognized, noise input along with the audio signal causes a problem of decreasing recognition accuracy. There have been attempts to prepare reference data according to noises in order to solve the problem that the recognition accuracy is decreased by the noise, but another problem of lowering resource efficiency and recognition rapidness arises because an enormous amount of reference data is needed due to a variety of noises. Further, the reference data for noise processing is irrelevant to present noise environments around the electronic apparatus, and rather decreases the recognition accuracy.

Therefore, a method of improving the resource efficiency, recognition rapidness, and the recognition accuracy is desired.

### SUMMARY

Provided are an electronic apparatus and a method of controlling the same, in which a present noise characteristic is taken into account to select reference data, and trigger command recognition adapted to a present noise environment of surroundings is performed, thereby improving resource efficiency, recognition rapidness and recognition accuracy.

According to an embodiment of the disclosure, an electronic apparatus may include a processor configured to: identify a noise characteristic based on a first audio signal received through a microphone, identify whether a second audio signal received through the microphone has a predetermined similarity level to a trigger command based on reference data, the reference data being selected from among pieces of reference data having a plurality of noise characteristics, respectively, and the selected reference data having a noise characteristic corresponding to the identified noise characteristic, and perform an operation corresponding to a user speech input based on a third audio signal received after the second audio signal having the predetermined similarity level.

The processor may be further configured to identify the noise characteristic based on the first audio signal received before a point in time of receiving the second audio signal.

The processor may be further configured to adjust a time section, in which the first audio signal is received, based on a magnitude of the identified noise characteristic.

The processor may be further configured to identify reference data having two or more noise characteristics corresponding to noise characteristics identified in two or more time sections identified in order of frame among the plurality of noise characteristics.

The processor may be further configured to assign a high weighting to reference data having a noise characteristic corresponding to a noise characteristic identified in a time section nearer to a point in time of receiving the second audio signal among the two or more noise characteristics.

The processor may be further configured to: identify a first noise characteristic of reference data, which has a similarity with a frequency pattern of the second audio signal that is higher than or equal to a first preset value, among the two or more noise characteristics, and modify the second audio signal using the reference data having the first noise characteristic, based on the identified first noise characteristic matching the noise characteristic of the reference data to which the high weighting is assigned.

The processor may be further configured to modify the second audio signal based on reference data having a second noise characteristic, which has a similarity with the frequency pattern of the second audio signal that is higher than or equal to a second preset value higher than the first preset value, among the two or more noise characteristics, based on the identified first noise characteristic mismatching the noise characteristic of the reference data to which the high weighting is assigned.

The processor may be further configured to: identify the plurality of noise characteristics; and provide a user interface to display the plurality of identified noise characteristics.

The processor may be further configured to provide the user interface such that the identified plurality of noise characteristics are distinguished from each other according to strength or kinds of the identified noise characteristics.

According to another aspect of the disclosure, a method of controlling an electronic apparatus may include identifying a noise characteristic based on a received first audio signal; identifying whether a received second audio signal has a predetermined similarity level to a trigger command based on reference data, the reference data being selected from among pieces of reference data having a plurality of noise characteristics, respectively, and the selected reference data having a noise characteristic corresponding to the identified noise characteristic; and performing an operation corresponding to a user speech input based on a third audio signal received after the second audio signal having the predetermined similarity level.

The identifying the noise characteristic may include identifying the noise characteristic based on the first audio signal received before a point in time of receiving the second audio signal.

The identifying the noise characteristic may include adjusting a time section, in which the first audio signal is received, based on a magnitude of the identified noise characteristic.

The method may further include identifying reference data having two or more noise characteristics corresponding to noise characteristics identified in two or more time sections identified in order of frame among the plurality of noise characteristics.

The method may further include assigning a high weighting to reference data having a noise characteristic corresponding to a noise characteristic identified in a time section nearer to a point in time of receiving the second audio signal among the two or more noise characteristics.

According to another aspect of the disclosure, a recording medium may include a computer program comprising a code, which performs a method of controlling an electronic apparatus, as a computer-readable code, the method comprising: identifying a noise characteristic based on a received first audio signal; identifying whether a received second audio signal has a predetermined similarity level to a trigger command based on reference data, the reference data being selected from among pieces of reference data having a plurality of noise characteristics, respectively, and the selected reference data having a noise characteristic corresponding to the identified noise characteristic; and performing an operation corresponding to a user speech input based on a third audio signal received after the second audio signal having the predetermined similarity level.

According to the disclosure, there are provided an electronic apparatus and a method of controlling the same, in which a present noise characteristic is taken into account to select reference data, and trigger command recognition adapted to a present noise environment of surroundings is performed, thereby improving resource efficiency, recognition rapidness and recognition accuracy.

### BRIEF DESCRIPTION OF THE DRAWINGS

FIG. 1 is a diagram of an electronic apparatus according to an embodiment.

FIG. 2 shows a configuration of the electronic apparatus of FIG. 1 and a server, according to an embodiment.

FIG. 3 is a flowchart of a method of speech recognition, according to an embodiment.

FIG. 4 is a diagram showing an example of identifying a noise characteristic, according to an embodiment.

FIG. 5 is a diagram showing an example of adjusting a time section, according to an embodiment.

FIG. 6 is a diagram showing an example of selecting one of a plurality of pieces of reference data, according to an embodiment.

FIG. 7 is a diagram showing an example of giving a weighting to reference data or adjusting the weighting, according to an embodiment.

FIG. 8 is a diagram showing an example of a control method of selecting reference data based on similarity and weighting among a plurality of pieces of reference data, according to an embodiment.

FIG. 9 is a diagram of an example of identifying reference data when a noise characteristic according to similarity identification is the same as a noise characteristic based on weighting, according to an embodiment.

FIG. 10 is a diagram of an example of identifying reference data when the noise characteristic according to the similarity identification are different from the noise characteristic based on the weighting, according to an embodiment.

FIG. 11 is a diagram of an example of a user interface showing a noise characteristic, according to an embodiment.

FIG. 12 shows user interface of FIG. 11 is displayed with different colors according to the noise characteristic, according to an embodiment.

FIG. 13 shows the user interface of FIG. 11 is set based on a user input, according to an embodiment.

### DETAILED DESCRIPTION

Below, example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

In the description of the following embodiments, elements illustrated in the accompanying drawings will be referenced, and like numerals or symbols set forth in the drawings refer to like elements having substantially the same operations.

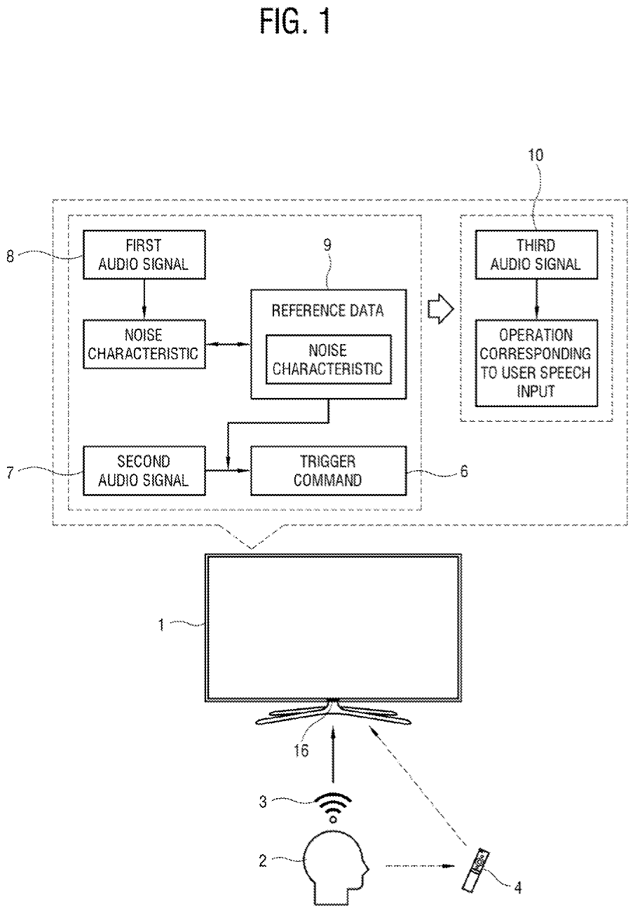

FIG. 1 is a diagram of an electronic apparatus according to an embodiment.

As shown in FIG. 1, an electronic apparatus 1 may be embodied by various kinds of apparatus such as a set-top box or the like having no display; a refrigerator, a washing machine or the like home appliances; a computer or the like information processing apparatus; etc. as well as a television (TV), a tablet computer, a portable media player (PMP), a wearable device, a video wall, an electronic frame, or the like image display apparatus. Further, the electronic apparatus 1 may be embodied by an artificial intelligence (AI) loudspeaker, an AI robot, etc. with an AI function. There are no limits to the kinds of electronic apparatus 1, and it will be described for convenience of description that the electronic apparatus 1 is embodied by the TV.

The electronic apparatus 1 may provide a speech recognition function. The electronic apparatus 1 may apply the speech recognition processing to a signal of an audio 3 uttered by a user 2. The electronic apparatus 1 may obtain a recognition result of the speech recognition processing, and may perform an operation corresponding to the obtained recognition result.

The speech recognition processing may include a speech-to-text (STT) process for converting the signal of the audio 3 into text data, and a command identification and execution process for identifying a command based on the text data and carrying out an operation based on the identified command. Although the electronic apparatus 1 can perform the whole speech recognition processing, at least a part of the processing may be performed in at least one server in communication with the electronic apparatus 1 through a network when a system load and a required storage capacity are taken into account. For example, at least one server performs the STT process, and the electronic apparatus 1 performs the command identification and execution process. Alternatively, at least one server may perform both the STT process and the command identification and execution process, and the electronic apparatus 1 may just receive a result from the at least one server.

The electronic apparatus 1 may receive the signal of the audio 3 through an internal microphone 16 provided in a main body thereof or through a remote controller 4 separated from the main body. In the case of using the remote controller 4, the signal of the audio 3 is received from the remote controller 4, and the speech recognition processing is applied to the received audio 3.

The electronic apparatus 1 may activate the speech recognition function based on a trigger command 6. The trigger command 6 may refer to a specific command for activating the speech recognition function. When the speech recognition function is activated in response to the trigger command 6, the foregoing speech recognition function may be performed with regard to a user speech input received subsequently to the trigger command 6 and an operation may be performed corresponding to the user speech input.

The electronic apparatus 1 may perform trigger command recognition based on reference data 9. The trigger command recognition may be performed based on identification of similarity between a second audio signal 7 and reference data 9. The second audio signal 7 may be input by a user 2 through the internal microphone 16 or the remote controller 4, but the disclosure is not limited thereto. The similarity identification may include identification similarity between frequency characteristics. The frequency characteristics may include at least one of a pattern, a tone, a strength, a speed, a period and an amplitude of a frequency. The reference data 9 may include an acoustic model related to the pattern or the like, and the acoustic model may be embodied by a hardware/software component.

The reference data 9 may be given according to sensitivities. The sensitivities may be a measure of how precisely the similarity with the frequency characteristics of the second audio signal 7 is identified. When the sensitivities are high, the similarity of the frequency characteristics may be identified with regard to an audio signal having weak frequency characteristics. On the other hand, when the sensitivities are low, the similarity of the frequency characteristics may be identified with regard to only an audio signal having strong frequency characteristics.

The reference data 9 may be given according to characteristics of noise. The noise may include not only wind sounds and the like natural noise, but may also floor noise, operation noise of home appliances and the like artificial noise. Further, the noise may include a speech input from the user 2 and a usual conversation. The speech input from the user 2 may include a speech command from the user 2 for controlling the electronic apparatus 1 or peripheral devices proving the speech recognition function. The usual conversation may include a chat, a call voice, etc. Further, the noise may include an audio of content output from the electronic apparatus 1. The audio of content may include an audio output based on an audio signal corresponding to an image of the content displayed on a display 14. A noise characteristic may refer to a characteristic of such noise, and may include at least one of a pattern, a tone, a strength, a speed, a frequency, a period, and an amplitude of the noise. For example, the reference data 9 may be provided corresponding to the levels of the noise, such as a low noise level, a high noise level, etc.

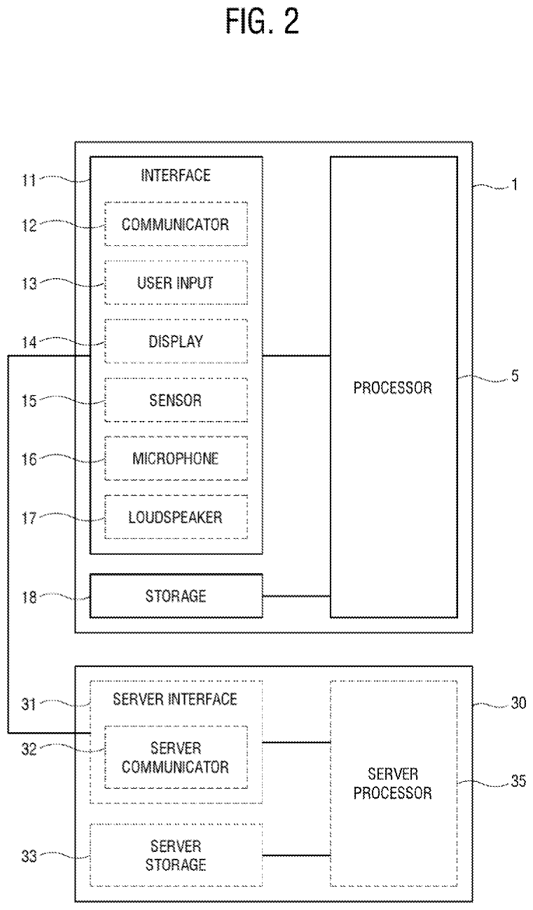

The noise may be received through the internal microphone 16 or the remote controller 4, but not limited thereto. Alternatively, the noise may be based on data received from another external apparatus or a server 30 (see FIG. 2) through a network.

The electronic apparatus 1 may identify a noise characteristic based on a first audio signal 8. The first audio signal 8 may be received through the internal microphone 16 or the remote controller 4, but not limited thereto. The noise characteristic may include a present noise environment around the electronic apparatus 1 before receiving the second audio signal 7. For example, when the low noise level is identified as the noise characteristic, the present noise environment before receiving the second audio signal 7 may show an environment of making a small amount of noise. On the other hand, when the high noise level is identified, the present noise environment may show an environment of making a large amount of noise.

The electronic apparatus 1 may identify the reference data 9 of the noise characteristic identified based the first audio signal 8. On the assumption that the noise characteristic of the first audio signal 8 includes the low noise level, the reference data 9 for little noise corresponding to the low noise level of the first audio signal 8 may be selected among pieces of the reference data 9 corresponding to little noise, much noise, etc. In other words, the reference data 9 is selected based on a present noise environment of the surroundings are an environment being a small amount of noise.

The electronic apparatus 1 may perform trigger command recognition based on the reference data 9 corresponding to the present noise environment of the surroundings. The trigger command recognition may include operations of noise removal based on the reference data 9, command detection, etc. The noise removal may include an operation of removing a noise component from the second audio signal 7 based on the noise characteristic of the reference data 9. The command detection may include an operation of identifying whether the second audio signal 7 from which the noise component is removed corresponds to the trigger command 6 based on similarity identified with respect to the reference data 9 and the frequency characteristics. The electronic apparatus 1 may perform the trigger command recognition in consideration of the present noise environment of the surroundings.

The electronic apparatus 1 may activate the speech recognition function when the second audio signal 7 is identified as the trigger command 6 based on the similarity identified in consideration of the present noise environment of the surroundings, perform the speech recognition processing as described above with regard to a third audio signal 10 received after the activation, and carry out an operation based on a recognition result.

All the foregoing operations of preparing the reference data, performing the trigger command recognition, etc. may be implemented by the electronic apparatus 1, but at least some operations may be implemented by the server 30 connected to and communicating with the electronic apparatus 1 through the network when a system load and a required storage capacity are taken into account. The server 30 may be involved in at least one server for the speech recognition processing, or may be separately provided. For example, the server 30 may implement the operations of preparing the reference data, performing the trigger command recognition, etc., and the electronic apparatus 1 may transmit the second audio signal 7 to the server 30 so that the server 30 can perform the foregoing operations or may only receive a processing result from the server 30.

In this way, the electronic apparatus 1 may select the reference data 9 based on the noise characteristic of the first audio signal 8 among the pieces of the reference data 9 prepared according to the noise characteristics, and may perform the trigger command recognition adapted to the present noise environment of the surroundings. Therefore, the trigger command recognition may be performed based on the reference data 9 optimized to the present noise environment, and thus resource efficiency, recognition rapidness and recognition accuracy may be improved as compared with those of when the trigger command recognition is performed using an enormous amount of reference data without considering the present noise environment of the surroundings.

FIG. 2 is a diagram showing a configuration of the electronic apparatus of FIG. 1 and a server, according to an embodiment.

Below, the configuration of the electronic apparatus 1 will be described with reference to FIG. 2. In this embodiment, it will be described that the electronic apparatus 1 is a TV. However, the electronic apparatus 1 may be embodied by various kinds of apparatuses, and this embodiment does not limit the configuration of the electronic apparatus 1. The electronic apparatus 1 may not be the display apparatus such as the TV, and, in this case, the electronic apparatus 1 may not include the display 14 or the like elements for displaying an image. For example, when the electronic apparatus 1 is embodied by a set-top box, the electronic apparatus 1 outputs an image signal to an external TV through an interface 11.

The electronic apparatus 1 may include the interface 11. The interface 11 may connect with the server 30, other external apparatuses and the like through the network, and transmits and receives data. However, without limitations, the interface 11 may connect with various apparatuses through the network.

The interface 11 may include a wired interface. The wired interface may include a connector or port to which an antenna for receiving a broadcast signal based on a terrestrial/satellite broadcast or the like broadcast standards is connectable, or a cable for receiving a broadcast signal based on cable broadcast standards is connectable. Alternatively, the electronic apparatus 1 may include a built-in antenna for receiving a broadcast signal. The wired interface may include a connector, a port, etc. based on video and/or audio transmission standards, like an HDMI port, DisplayPort, a DVI port, a thunderbolt, composite video, component video, super video, syndicat des constructeurs des appareils radiorécepteurs et téléviseurs (SCART), etc. The wired interface may include a connector, a port, etc. based on universal data transmission standards like a universal serial bus (USB) port, etc. The wired interface may include a connector, a port, etc. to which an optical cable based on optical transmission standards is connectable.

The wired interface may include a connector, a port, etc. to which an internal microphone 16 or an external audio device including a microphone may be connected, and which receives or inputs an audio signal from the audio device. The wired interface may include a connector, a port, etc. to which a headset, an earphone, an external loudspeaker or the like audio device is connected, and which transmits or outputs an audio signal to the audio device. The wired interface may include a connector or a port based on Ethernet or the like network transmission standards. For example, the wired interface may be a local area network (LAN) card or the like connected to a router or a gateway by a wire.

The wired interface may be connected to a set-top box, an optical media player or the like external apparatus or an external display apparatus, a loudspeaker, a server 30, etc. by a cable in a manner of one to one or one to N (where, N is a natural number) through the connector or the port, thereby receiving a video/audio signal from the corresponding external apparatus or transmitting a video/audio signal to the corresponding external apparatus. The wired interface may include connectors or ports to individually transmit video/audio signals.

The wired interface may be embodied as built in the electronic apparatus 1, or may be embodied in the form of a dongle or a module and detachably connected to the connector of the electronic apparatus 1.

The interface 11 may include a wireless interface. The wireless interface may be embodied variously corresponding to the types of the electronic apparatus 1. For example, the wireless interface may use wireless communication based on radio frequency (RF), Zigbee, Bluetooth, Wi-Fi, ultra-wideband (UWB), near field communication (NFC) etc. The wireless interface may be embodied by a wireless communication module that performs wireless communication with an access point (AP) based on Wi-Fi, a wireless communication module that performs one-to-one direct wireless communication such as Bluetooth, etc.

The wireless interface may wirelessly communicate with a server 30 on a network to thereby transmit and receive a data packet to and from the server 30. The wireless interface may include an infrared (IR) transmitter and/or an IR receiver to transmit and/or receive an IR signal based on IR communication standards.

The wireless interface may receive or input a remote control signal from a remote controller 4 or other external devices, or transmit or output the remote control signal to the remote controller 4 or other external devices through the IR transmitter and/or IR receiver. Alternatively, the electronic apparatus 1 may transmit and receive the remote control signal to and from the remote controller 4 or other external devices through the wireless interface based on Wi-Fi, Bluetooth or the like other standards.

The electronic apparatus 1 may further include a tuner to be tuned to a channel of a received broadcast signal, when a video/audio signal received through the interface 11 is a broadcast signal.

The electronic apparatus 1 may include a communicator 12. The communicator 12 may be to the server 30, other external apparatuses or the like and transmits the video/audio signal. The communicator 12 may be designed to include at least one of the wired interface or the wireless interface, and performs at least one function of the wired interface or the wireless interface.

The electronic apparatus 1 may include a user input 13. The user input 13 may include various kinds of circuits related to an input interface, which is provided to be controlled by a user 2 so that the user 2 can make an input. The user input 13 may be variously embodied according to the kinds of electronic apparatus 1, and may, for example, include mechanical or electronic buttons of the electronic apparatus 1, a touch pad, a touch screen installed in the display 14, etc.

The electronic apparatus 1 may include the display 14. The display 14 may include a display panel for displaying an image on a screen. The display panel may have a light-receiving structure like a liquid crystal type or a light-emitting structure like an OLED type. The display 14 may include an additional component according to the types of the display panel. For example, when the display panel is of the liquid crystal type, the display 14 includes a liquid crystal display (LCD) panel, a backlight unit for emitting light, a panel driving substrate for driving the liquid crystal of the LCD panel. However, as described above, the display 14 is excluded when the electronic apparatus 1 is embodied by a set-top box or the like.

The electronic apparatus 1 may include a sensor 15. The sensor 15 may perform detecting in front of the electronic apparatus 1, and may detect the presence, motion, etc. of the user 2 or other electronic apparatuses. For example, the sensor 15 may be embodied by an image sensor, performs capturing in a frontward direction of the electronic apparatus 1, and obtain information about the presence, motion, etc. of the user 2 or other electronic apparatuses from the captured image. The image sensor may be embodied by a camera using a complementary metal oxide semiconductor (CMOS) or a charge coupled device (CCD). The sensor 15 may be embodied by an infrared sensor, measure time taken by an infrared signal output frontward to return back, and obtain information about the presence, motion, etc. of the user 2 or other electronic apparatuses.

The electronic apparatus 1 may include the microphone 16. The microphone 16 may receive various audio signals. The microphone 16 may receive not only an audio 3 from a user 2, but also an audio signal of noise such as noise introduced from surroundings. The microphone 16 may transmit a collected audio signal to a processor 5. The microphone 16 may be embodied by an internal microphone 16 provided in the electronic apparatus 1 or an external microphone provided in the remote controller 4 separated from the main body. When the microphone 16 is embodied by the external microphone, the audio signal received in the external microphone may be digitalized and transmitted from the remote controller 4 to the processor 5 through the interface 11.

The remote controller 4 may include a smartphone or the like, and the smartphone or the like is installed with a remote controller application. The smartphone may perform a function of the remote controller 4 with the installed application, for example, a function of controlling the electronic apparatus 1. Such a remote controller application is installable in various external apparatuses such as an AI loudspeaker, an AI robot, etc.

The electronic apparatus 1 may include a loudspeaker 17. The loudspeaker 17 may output various audios based on an audio signal. The loudspeaker 17 may be embodied by at least one loudspeaker. The loudspeaker 17 may be embodied by an internal loudspeaker provided in the electronic apparatus 1 or an external loudspeaker provided at the outside. When the loudspeaker 17 is embodied by the external loudspeaker, the electronic apparatus 1 may transmit an audio signal to the external loudspeaker by a wire or wirelessly.

The user input 13, the display 14, the sensor 15, the microphone 16, the loudspeaker 17, etc. are provided separately from the interface 11, but may be designed to be included in the interface 11.

The electronic apparatus 1 may include a storage 18. The storage 18 may be configured to store digitalized data. The storage 18 may include a nonvolatile storage in which data is retained regardless of whether power is on or off. The nonvolatile storage may include a flash memory, a hard-disc drive (HDD), a solid-state drive (SSD), a read only memory (ROM), etc.

The storage 18 may include a volatile memory into which data to be processed by the processor 5 is loaded and in which data is retained only when power is on. The memory may include a buffer, a random-access memory (RAM), etc. For example, a first code of a first application 1 is loaded into the storage 18.

The electronic apparatus 1 may include the processor 5. The processor 5 may include one or more hardware processors embodied as a central processing unit (CPU), a chipset, a buffer, a circuit, etc. which are mounted onto a printed circuit board, and may be designed as a system on chip (SOC). When the electronic apparatus 1 is embodied as a display apparatus, the processor 5 may include modules corresponding to various processes, such as a demultiplexer, a decoder, a scaler, an audio digital signal processor (DSP), an amplifier, etc. Here, some or all of such modules may be embodied as an SOC. For example, the demultiplexer, the decoder, the scaler and the like video processing modules may be embodied as a video processing SOC, and the audio DSP may be embodied as a chipset separated from the SOC.

The processor 5 may identify the present noise characteristic based on the first audio signal 8 received through the microphone 16.

To identify similarity between the audio signal and the trigger command, the processor 5 may identify whether the second audio signal 7 received through the microphone 16 matches the trigger command 6, based on the reference data 9 for the noise characteristic corresponding to the identified present noise characteristic among the pieces of the reference data 9 prepared according to the plurality of noise characteristics.

The processor 5 may perform an operation related to recognition of a voice command based on the third audio signal 10 received through the microphone 16 after the second audio signal 7 identified as matching the trigger command 6.

The configuration of the electronic apparatus 1 is not limited to that shown in FIG. 2, but may be designed to exclude some elements from the foregoing configuration or include other elements in addition to the foregoing configuration.

Below, the configuration of the server 30 will be described in detail with reference to FIG. 2. The server 30 may include a server interface 31. The electronic apparatus 1 and the server 30 may be connected through the interface 11 and the server interface 31, and exchange the data. The server interface 31 may include a wired interface and a wireless interface. The wired interface and the wireless interface are equivalent to those included in the interface 11 of the electronic apparatus 1, and thus repetitive descriptions thereof will be avoided as necessary.

The server 30 may include a server communicator 32. The server communicator 32 may be connected to the electronic apparatus 1, other external apparatuses, etc. through the network and transmits data. The server communicator 32 may be designed to include at least one of the wired interface or the wireless interface, and may perform a function of the at least one of the wired interface or the wireless interface.

The server 30 may include a server storage 33. The server storage 33 may be configured to store digitalized data. The server storage 33 may include a nonvolatile storage in which data is retained regardless of whether power is on or off. The nonvolatile storage may include a flash memory, a HDD, a SSD, a ROM, etc. The server storage 33 may include a volatile memory into which data to be processed by a server processor 35 is loaded and in which data is retained only when power is on. The memory may include a buffer, a RAM, etc.

The server 30 may include the server processor 35. The server processor 35 may include one or more hardware processors embodied as a CPU, a chipset, a buffer, a circuit, etc. which are mounted onto a printed circuit board, and may be designed as an SOC.

The server processor 35 may perform all or some of the foregoing operations of the processor 5. For example, at least one of the operations of identifying the present noise characteristic, identifying whether the second audio signal 7 matches the trigger command 6, and recognizing the voice command may be performed by the server processor 35. In this case, the processor 5 may provide necessary information so that the server processor 35 can perform the foregoing operations, or may receive information processed by the server processor 35.

The configuration of the server 30 is not limited to that shown in FIG. 2, but may be designed to exclude some elements from the foregoing configuration or include other elements in addition to the foregoing configuration.

The processor 5 of the electronic apparatus 1 or the server processor 35 of the server 30 may apply AI technology based on rules or using an AI algorithm to at least a part of analyzing and processing data and generating information about results to perform their own operations, thereby building up an AI system.

The AI system may refer to a computer system that has an intelligence level of a human, in which a machine learns and determines by itself, and gets higher recognition rates the more it is used. The AI algorithm refers to an algorithm that classifies/learns features of input data by itself.

The AI technology may be based on elementary technology by using at least one of machine learning, neural network, or deep learning algorithm to copy perception, determination and the like functions of a human brain.

The elementary technology may include at least one of linguistic comprehension technology for recognizing a language/text of a human, visual understanding technology for recognizing an object like a human sense of vision, inference/prediction technology for identifying information and logically making inference and prediction, knowledge representation technology for processing experience information of a human into knowledge data, and motion control technology for controlling a vehicle's automatic driving or a robot's motion.

The linguistic comprehension may refer to technology of recognizing and applying/processing a human's language/character, and includes natural language processing, machine translation, conversation system, question and answer, speech recognition/synthesis, etc. The visual understanding may refer to technology of recognizing and processing an object like a human sense of vision, and includes object recognition, object tracking, image search, people recognition, scene understanding, place understanding, image enhancement, etc. The inference/prediction may refer to technology of identifying information and logically making prediction, and includes knowledge/possibility-based inference, optimized prediction, preference-based plan, recommendation, etc. The knowledge representation may refer to technology of automating a human's experience information into knowledge data, and includes knowledge building (data creation/classification), knowledge management (data utilization), etc.

Below, it will be described by way of example that the AI technology using the foregoing AI algorithm is achieved by the processor 5 of the electronic apparatus 1. However, the same AI technology may also be achieved by the server processor 35 of the server 30.

The processor 5 may function as both a learner and a recognizer. The learner may perform a function of generating the learned neural network, and the recognizer may perform a function of recognizing (inferring, predicting, estimating and identifying) the data based on the learned neural network.

The learner may generate or update the neural network. The learner may obtain learning data to generate the neural network. For example, the learner obtains the learning data from the storage 18 or a server storage 33 or from the outside. The learning data may be data used for learning the neural network, and the data subjected to the foregoing operations may be used as the learning data to make the neural network learn.

Before making the neural network learn based on the learning data, the learner may perform a preprocessing operation with regard to the obtained learning data or selects data to be used in learning among a plurality of pieces of the learning data. For example, the learner processes the learning data to have a preset format, apply filtering to the learning data, or processes the learning data to be suitable for the learning by adding/removing noise to/from the learning data. The learner uses the preprocessed learning data for generating the neural network which is set to perform the operations.

The learned neural network may include a plurality of neural networks or layers. The nodes of the plurality of neural networks may have weight values, and the plurality of neural networks may be connected to one another so that an output value of a certain neural network can be used as an input value of another neural network. As an example of the neural network, there are a convolutional neural network (CNN), a deep neural network (DNN), a recurrent neural network (RNN), a restricted Boltzmann machine (RBM), a deep belief network (DBN), a bidirectional recurrent deep neural network (BRDNN) and deep Q-networks.

The recognizer may obtain target data to carry out the foregoing operations. The target data may be obtained from the storage 140 or from the outside. The target data may be data targeted to be recognized by the neural network. Before applying the target data to the learned neural network, the recognizer may perform a preprocessing operation with respect to the obtained target data, or selects data to be used in recognition among a plurality of pieces of target data. For example, the recognizer processes the target data to have a preset format, apply filtering to the target data, or processes the target data into data suitable for recognition by adding/removing noise. The recognizer may obtain an output value output from the neural network by applying the preprocessed target data to the neural network. Further, the recognizer may obtain a stochastic value or a reliability value together with the output value.

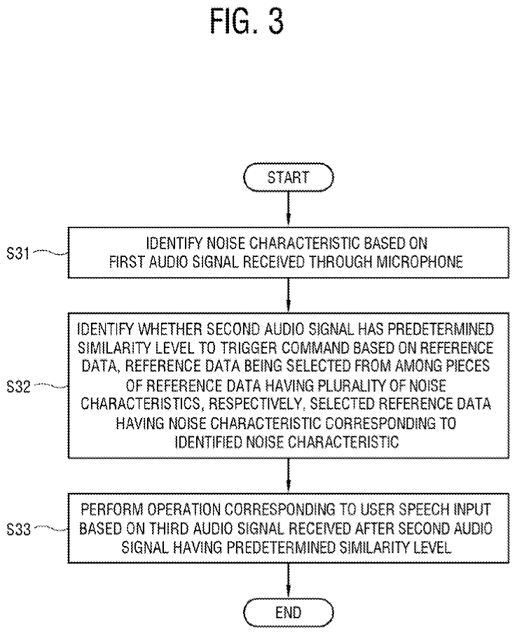

FIG. 3 is a flowchart of a method speech recognition according to an embodiment.

Operations described below with reference to FIG. 3 may be performed as the processor 5 executes a program stored in the storage 18, but, for convenience of description, the operations will be described as performed by the processor 5.

The processor 5 may identify a noise characteristic based on the received first audio signal 8 (S31).

The processor 5 may identify whether the received second audio signal 7 has a predetermined similarity level to the trigger command 6 based on reference data 9. The reference data is selected from among pieces of reference data having a plurality of noise characteristics, respectively. The selected reference data having a noise characteristic corresponding to the identified noise characteristic (S32).

The processor 5 may perform an operation corresponding to a user speech input based on the third audio signal 10 received through the microphone 16 after the second audio signal 7 having the predetermined similarity level (S33).

In this way, the processor 5 selects the reference data 9 based on the noise characteristic of the first audio signal 8 among the pieces of the reference data 9 prepared according to the noise characteristics, and thus performs the trigger command recognition adapted to the present noise environment of the surroundings. Therefore, the resource efficiency, the recognition rapidness and the recognition accuracy are improved as compared with those of when the trigger command recognition is performed using an enormous amount of reference data without considering the present noise environment of the surroundings.

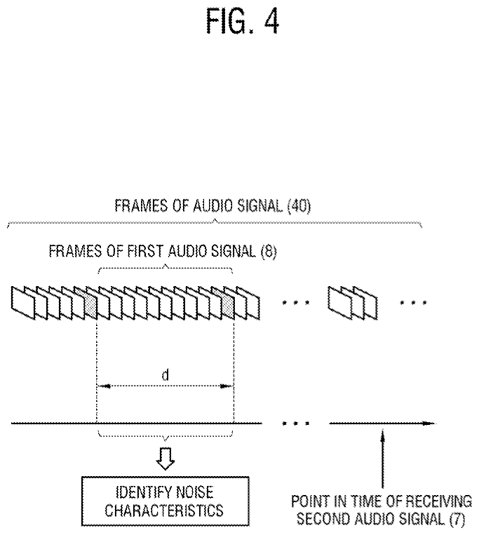

FIG. 4 is a diagram showing example of identifying noise characteristic, according to an embodiment.

As described above with reference to FIG. 1, the processor 5 may identify the reference data 9 based on the noise characteristic identified based on the first audio signal 8, and may perform the trigger command recognition with regard to the second audio signal 7 based on the identified reference data 9. Below, it will be described with reference to FIG. 4 that noise characteristic is identified based on a time section d of the first audio signal 8.

As shown in FIG. 4, it will be assumed that the processor 5 receives an audio signal 40. The processor 5 may identify the noise characteristic based on the first audio signal 8 received in the time section d among the audio signals 40. The time section d may include a time section d previously set before a point in time of receiving the second audio signal 7. The point in time of receiving the second audio signal 7 may be designed to include a point in time of recognizing the second audio signal 7, and the time section d may be designed to include a time section d previously set after a point in time of receiving or recognizing the second audio signal 7. In other words, the time section d may be set regardless of before or after the point in time of receiving or recognizing the second audio signal 7, and therefore the time section d may for example overlap with the point in time of receiving or recognizing the second audio signal 7.

When the audio signal 40 includes a plurality of frames, the present noise characteristic may be identified based on at least one frame corresponding to the time section d before the point in time of receiving the second audio signal 7 among the plurality of frames. The processor 5 may process the audio signal 40 in units of frame, while buffering the time section d and a time section corresponding to the second audio signal 7. When the existing noise characteristic is present, the existing noise characteristic may be updated based on the noise characteristic of the time section d.

The length or period of the time section d may be variously set. For example, the length of the time section d may be increased to improve the identification accuracy of the noise characteristic. Alternatively, the length of the time section d may be decreased to improve the resource efficiency. The time section d may be aperiodically set.

The processor 5 may identify the present noise environment of the surroundings based on the identified noise characteristic. The noise characteristic may be identified based on at least one of the pattern, tone, strength, speed, frequency, period and amplitude of the noise included in the first audio signal 8. For example, the present noise environment may be identified as an environment of operating a vacuum cleaner, based on a frequency pattern corresponding to operation noise of the vacuum cleaner. Alternatively, the present noise environment may be identified as an environment of making a small amount of noise, based on a low noise level.

The electronic apparatus 1 may identify reference data 9 of a noise characteristic corresponding to the noise characteristic of the first audio signal 8. For example, when the noise characteristic of the first audio signal 8 exhibit the operation noise of the vacuum cleaner, the reference data 9 may be identified corresponding to the vacuum cleaner. Alternatively, when the noise characteristic of the first audio signal 8 exhibit a low noise level, the reference data 9 may be identified corresponding to the low noise level. In other words, the electronic apparatus 1 may identify the reference data 9 reflecting the present noise environment of the surroundings.

In this way, the processor 5 may identify the noise characteristic based on the first audio signal 8 received in a specific time section d before the point in time of receiving the second audio signal 7, thereby improving the resource efficiency in identifying the noise characteristic as compared with that of when the noise characteristic is identified without considering the specific time section d.

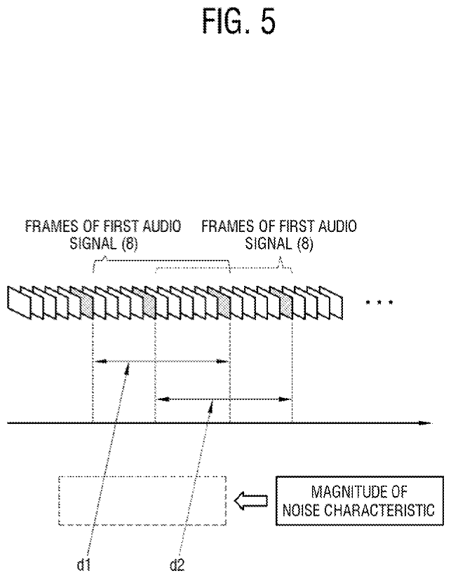

FIG. 5 is a diagram of an example of adjusting a time section, according to an embodiment.

As described above with reference to FIG. 4, the processor 5 may identify the time section d based on the magnitude of the noise characteristic of the first audio signal 8. Below, a process of adjusting the time section d will be described with reference to FIG. 5.

For convenience of description, when the magnitude of the noise characteristic is a frequency magnitude by way of example, the first audio signal 8 may be identified as having a low frequency magnitude in majority time section of a first time section d1, but identified as having a high frequency magnitude in a minority time section of the first time section d1. In this case, the processor 5 may expand the first time section d1 or convert the first time section d1 itself into a second time section d2 as shown in FIG. 5, in order to identify whether the high frequency magnitude is temporary or persistent. The second time section d2 may be converted to be subsequent to the first time section d1, for example, be near to a start point in time of the second audio signal 7. However, without limitations, the second time section d2 may be converted into various time sections.

When the high frequency magnitude is persistently identified even in the converted second time section d2, it may be identified that the frequency magnitude is high in the second time section d2. On the other hand, when the high frequency magnitude is temporary, it may be identified that the frequency magnitude is low. However, there are no limits to the adjustment of the time section d based on the magnitude of the noise characteristic, and thus the time section d may be adjusted according to various environments.

In this way, the processor 5 may adjust the time section d based on the magnitude of the noise characteristic of the first audio signal 8, and identifies the noise characteristic based on the adjusted time section d, thereby improving accuracy in identifying the noise characteristic of the first audio signal 8.

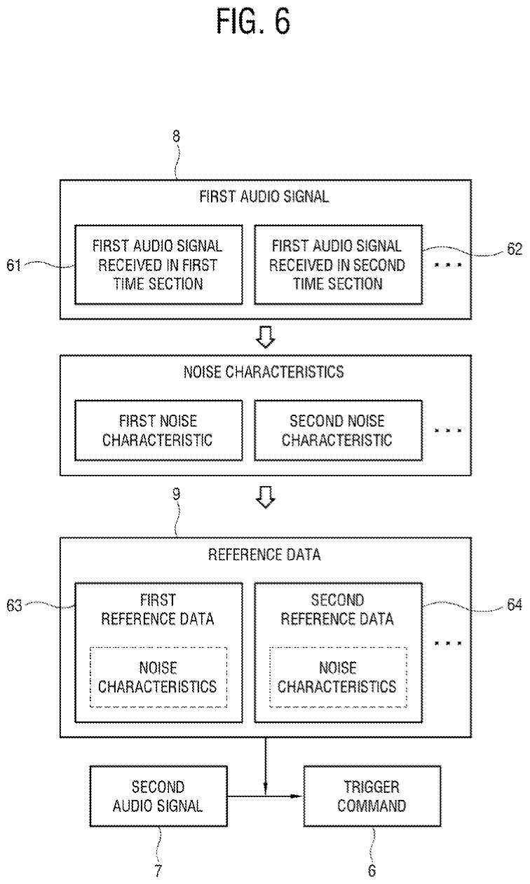

FIG. 6 is a diagram of an example of selecting one of a plurality of pieces of reference data, according to an embodiment.

Below, it will be described that one of the pieces of the reference data is selected based on the noise characteristic of the first audio signal 8 on the assumption that first reference data 63 and second reference data 64 are prepared as shown in FIG. 6. However, there are no limits to the number of pieces of the reference data 9, and therefore various numbers of pieces of the reference data 9 may be prepared.

The first reference data 63 and the second reference data 64 are respectively provided based on noise characteristic different from each other. For example, the first reference data 63 may be provided corresponding to a low noise level, and the second reference data 64 may be provided corresponding to a high noise level.

The processor 5 may identify noise characteristic based on the first audio signal 8 received in the time section d before a point in time of receiving the second audio signal 7 in order to recognize a trigger command with regard to the second audio signal 7, and select the reference data 9 of the noise characteristic corresponding to the identified noise characteristic. For example, when the first noise characteristic is identified as the low noise level based on a frame of a first audio signal 61 received in the first time section d1, the processor 5 identifies the first reference data 63 provided corresponding to the low noise level, and selects the first reference data 63 as the reference data in order to recognize the trigger command with regard to the second audio signal 7.

It will be assumed that a second noise characteristic different from the first noise characteristic is identified based on the first audio signal 61 received in the first time section d1. For example, when the first noise characteristic is identified as the high noise level based on the frame of the first audio signal 61 received in the first time section d1, the processor 5 identifies the second reference data 64 prepared corresponding to the high noise level, and selects the second reference data 64 as the reference data for the trigger command recognition with regard to the second audio signal 7.

As described above with reference to FIG. 5, the first noise characteristic or the second noise characteristic may be identified based on a frame of a first audio signal 62 received in the second time section different from the first time section d1, and, in this case, the first reference data 63 or the second reference data 64 of the noise characteristic corresponding to each noise characteristic may be selected as described above.

In this way, the processor 5 may perform the trigger command recognition based on the reference data 9 selected based on the noise characteristic of the frame of the first audio signal 62 among the plurality of pieces of reference data 9 prepared according to the noise characteristics. Therefore, the reference data 9 may be more optimized to a present noise environment than a single piece of reference data is identified, thereby improving resource efficiency, recognition rapidness and recognition accuracy in terms of recognizing a trigger command based on a reference data.

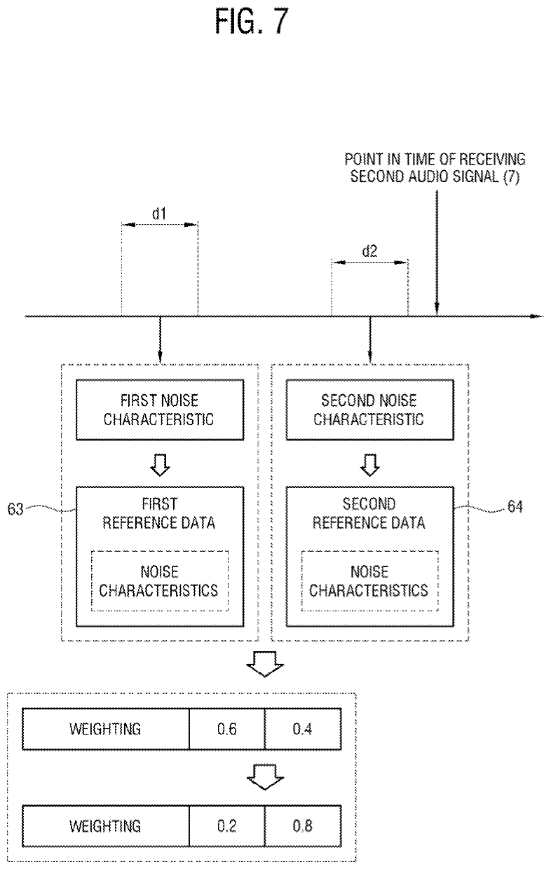

FIG. 7 is a diagram of an example of giving a weighting to reference data or adjusting the weighting, according to an embodiment.

The processor 5 may give a weighting to the reference data 9 prepared according to the noise characteristics. The processor 5 may select the reference data 9, which is given a high weighting, in terms of selecting the reference data 9 to recognize a trigger command. For example, as shown in FIG. 7, when the weighting of the second reference data 64 is higher than the weighting of the first reference data 63, the second reference data 64 may be selected.

More weighting may be given to the reference data of a noise characteristic corresponding to the noise characteristic in the second time section d2 among the noise characteristics of the first reference data 63 and the second reference data 64. For more specific description, it will be assumed that the first reference data 63 has a noise characteristic corresponding to the first noise characteristic in the first time section d1 and the second reference data 64 has a noise characteristic corresponding to the second noise characteristic in the second time section d2. Further, it will be assumed that the first reference data 63 is given an initial weighting of ‘0.6’ and the second reference data 64 is given an initial weighting of ‘0.4’. However, the initial weightings are merely for convenience of description, and thus variously set according to designing methods.

Because the second time section d2 is nearer to the point in time of receiving the second audio signal 7 than the first time section d1, a higher weighting may be given to the second reference data 64 having the noise characteristic corresponding to the second noise characteristic of the second time section d2. For example, when a weighting changing amount is set to ‘0.4’, the weighting of the second reference data 64 may be changed from the initial weighting of ‘0.4’ to ‘0.8’, and the weighting of the first reference data 63 may be changed from the initial weighting of ‘0.6’ to ‘0.2’. The weighting may be adjusted so that the sum of weightings can be ‘1’, but not limited thereto.

The weighting changing amount may be varied depending on how near the time section d is to a start section of the second audio signal 7. For example, when the second time section d2 comes near to the start section of the second audio signal 7, the weighting changing amount may be set to ‘0.5’. Therefore, the weight of the second reference data 64 having a noise characteristic corresponding to the second noise characteristic of the second time section d2 may be changed from the initial weighting of ‘0.4’ to ‘0.9’. However, the weighting changing amount may be set in proportion to how nearer the second time section d2 is to the start section of the second audio signal 7, but not limited thereto. Alternatively, the weighting changing amount may be variously set according to designing methods.

In this way, the processor 5 may select the reference data 9, to which a higher weighting is given, based on a relationship between the time sections d1 and d2 of the first audio signal and the point in time of receiving the second audio signal 7. Because the selectin of the reference data 9 which is given a higher weighting is selection of the reference data 9 which is adapted to the present noise environment, the processor 5 may use the reference data 9 more adapted to the present noise environment in terms of recognizing the trigger command.

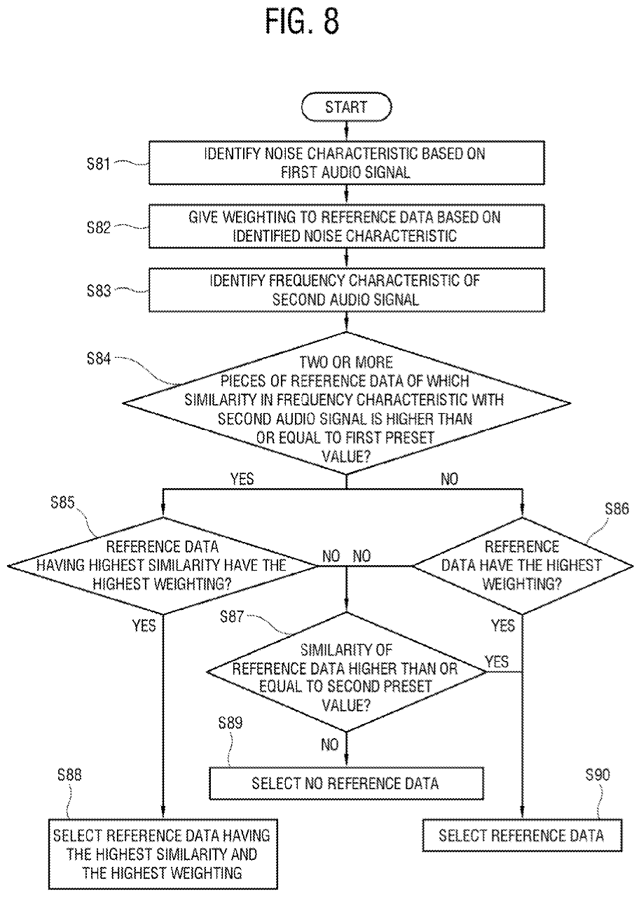

FIG. 8 is a diagram of a control method of selecting reference data based on similarity and weighting among a plurality of pieces of reference data, according to an embodiment.

The processor 5 may identify a noise characteristic based on the first audio signal 8 (S81), and may give weightings to the pieces of the reference data 9 based on the identified noise characteristic (S82). As described above with reference to FIGS. 6 and 7, the processor 5 may consider how nearer the time section d of receiving the first audio signal 8 and the point in time of receiving the second audio signal 7, in terms of giving the weightings.

The processor 5 may identify a frequency characteristic of the second audio signal 7 (S83), and may identify whether there are two or more pieces of the reference data 9, of which similarity in a frequency characteristic with the second audio signal 7 is higher than or equal to a first preset value (S84).

In connection with the operation S84, when two or more pieces of the reference data 9, of which the similarity in the frequency characteristic with the second audio signal 7 is higher than or equal to the first preset value, are present, the processor 5 may identify whether the reference data 9 having the highest similarity among the two or more pieces of the reference data 9 is also given the highest weighting (S85).

In connection with the operation S85, when the reference data 9 having the highest similarity is also given the highest weighting, the processor 5 may select the reference data 9 having the highest similarity and the highest weighting (S88).

On the other hand, in connection with the operation S85, when the reference data 9 having the highest similarity is not given the highest weighting, the processor 5 may identify whether the similarity of the reference data 9 is higher than or equal to a second preset value (S87). The second preset value may be higher than the first preset value.

In connection with the operation S87, when the similarity of the reference data 9 is higher than or equal to the second preset value, the processor 5 may select the reference data 9 (S90).

On the other hand, in connection with the operation S87, when the similarity of the reference data 9 is lower than the second preset value, the processor 5 does not select any piece of the reference data 9 (S89).

In connection with the operation S84, when two or more pieces of the reference data 9, of which the similarity in the frequency characteristic with the second audio signal 7 is higher than or equal to the first preset value, are not present, the processor 5 may identify whether the reference data 9 is given the highest weighting (S86).

In connection with the operation S86, when the reference data 9 is given the highest weighting, the reference data 9 is selected like the foregoing operation S90.

On the other hand, in connection with the operation S86, when the reference data 9 does not have the highest weighting, the processor 5 may select the reference data 9 (S90) or may not select any piece of the reference data 9 according to whether the similarity of the reference data 9 is higher than or equal to a second preset value as described above in the operation S87.

In this way, the processor 5 may select the reference data 9 in consideration of the similarity in the frequency characteristic with the second audio signal 7 and the weighting given based on the noise characteristic, thereby further improving the recognition accuracy with regard to the trigger command 6.

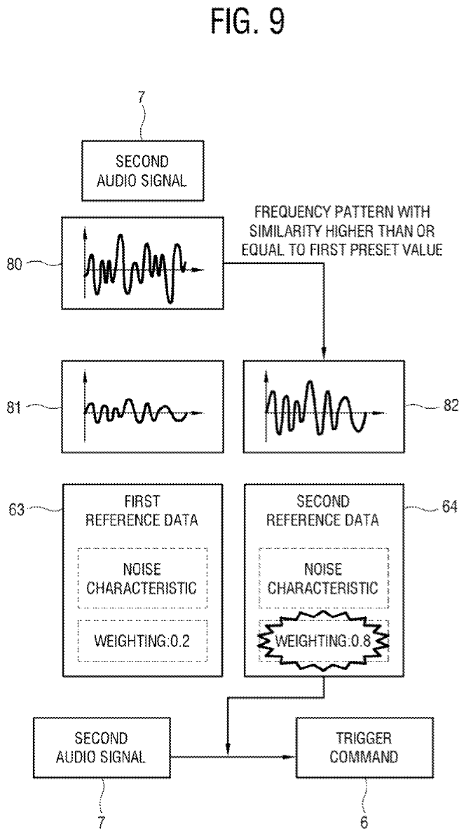

FIG. 9 shows an example of identifying reference data when noise characteristic according to similarity identification are the same as noise characteristic based on weighting, according to an embodiment.

As described above with reference to FIG. 8, the processor 5 may identify the similarity in the frequency characteristic with the second audio signal 7. Below, for convenience of description, on the assumption that the frequency characteristic is a frequency pattern, it will be described that the reference data 9 is identified based on the similarity identification of the frequency pattern.

The reference data 9 may be prepared according to the frequency patterns. As shown in FIG. 9, the first reference data 63 may be provided corresponding to a first frequency pattern 81, and the second reference data 64 may be provided corresponding to a second frequency pattern 82 different from the first frequency pattern 81. However, the frequency pattern is merely given for convenience of description, and thus variously provided according to designing methods.

The processor 5 may identify the noise characteristic of the reference data 9, of which similarity in the frequency pattern 80 with the second audio signal 7 is higher than or equal to the first preset value, as the first noise characteristic. For example, when the second audio signal 7 has the frequency pattern 80 as shown in FIG. 9, the processor 5 may identify that the similarity between the frequency pattern 80 of the second audio signal 7 and the second frequency pattern 82 of the second reference data 64 is higher than or equal to the first preset value. Therefore, the processor 5 may identify the noise characteristic of the second reference data 64 as the first noise characteristic.

As described above with reference to FIG. 7, the processor 5 gives a higher weighting to the reference data 9 based on a relationship between the time sections d1 and d2 of the first audio signal 8 and the recognition section of the second audio signal 7. When it is assumed for convenience of description that the first reference data 63 is given a weighting of ‘0.2’ and the second reference data 64 is given a weighting of ‘0.8’, the noise characteristic of the second reference data 64 identified as the first noise characteristic matches the noise characteristic of the second reference data 64 to which a high weighting is given, and thus the processor 5 identifies the second reference data 64 of the noise characteristic, which is identified as the first noise characteristic, as the reference data 9 for the trigger command recognition.

However, the identification of the reference data 9 based on the similarity and weighting of the frequency pattern may be varied depending on designing methods. For example, any piece of the reference data 9 may not be selected when the first frequency pattern 81 of the first reference data 63 and the second frequency pattern 82 of the second reference data 64 have similarities in the frequency pattern 80 with the second audio signal 7, the similarities being lower than the first preset value.

In this way, the processor 5 identifies the reference data 9 in consideration of the similarity in the frequency pattern with the second audio signal 7 and the weighting given based on the noise characteristic, thereby further improving the recognition accuracy with regard to the trigger command 6.

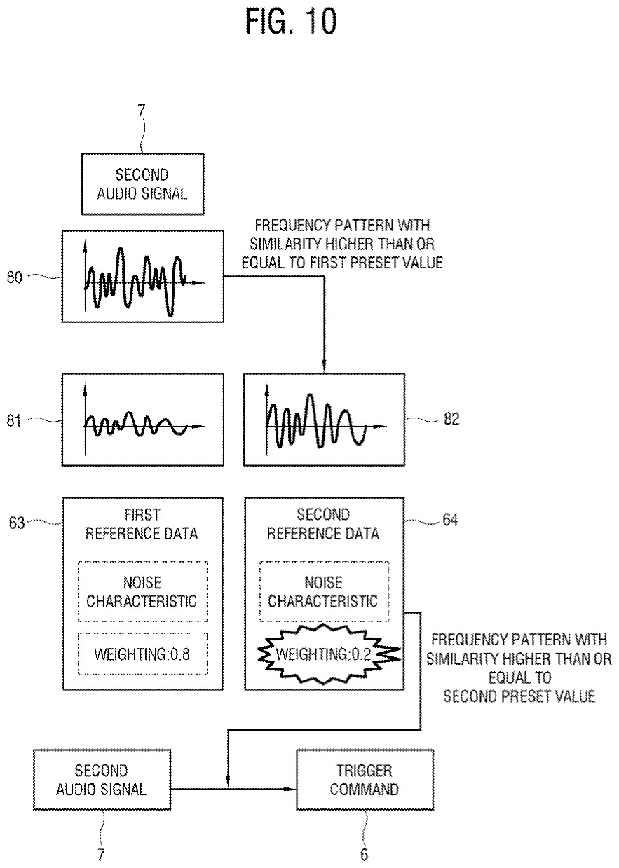

FIG. 10 illustrates a concrete example of identifying reference data when the noise characteristic according to the similarity identification are different from the noise characteristic based on the weighting, according to an embodiment.

It has been described above with reference to FIG. 9 that the noise characteristic of the second reference data 64 identified as the first noise characteristic matches the noise characteristic of the second reference data 64 to which a high weighting is given, and thus the processor 5 identifies the second reference data 64 of the noise characteristic, which is identified as the first noise characteristic, as the reference data for the trigger command recognition.

However, the noise characteristic of the second reference data 64 identified as the first noise characteristic may not match the noise characteristic of the second reference data 64 to which a high weighting is given. Under this condition, a process of identifying the reference data for the trigger command recognition will be described below.

As described with reference to FIG. 7, it will be assumed that the similarity between the frequency pattern 80 of the second audio signal 7 and the second frequency pattern 82 of the second reference data 64 is identified as being higher than the first preset value, and the noise characteristic of the second reference data 64 is identified as the first noise characteristic. On the other hand, unlike the description of FIG. 7, it will be assumed that the first reference data 63 is given a weighting of ‘0.8’ and the second reference data 64 is given a weighting of ‘0.2’.

Like this, when the noise characteristic of the second reference data 64 identified as the first noise characteristic does not match the noise characteristic of the first reference data 63 to which a high weighting is given, the processor 5 identifies the second noise characteristic of the reference data 9, of which the similarity in the frequency pattern 80 with the second audio signal 7 is higher than the second preset value. The second preset value is higher than the first preset value. When the similarity between the frequency pattern 80 of the second audio signal 7 and the frequency pattern 82 of the second reference data 64 is higher than or equal to the second preset value, the processor 5 may identify the nose characteristic of the second reference data 64 as the second noise characteristic, and use the second reference data 64 of the second noise characteristic as the reference data for the trigger command recognition.

However, the recognition of the reference data 9 based on the similarity in the frequency pattern and the weighting may be varied depending on designing methods. For example, even though the noise characteristic of the second reference data 64 identified as the first noise characteristic does not match the noise characteristic of the first reference data 63 given the high weighting, the processor 5 may identify the noise characteristic of the first reference data 63 given the high weighting as the second noise characteristic, and use the first reference data 63 of the second noise characteristic as the reference data for the trigger command recognition.

In this way, the processor 5 may identify the reference data 9 in consideration of the similarity in the frequency pattern with the second audio signal 7 and the weighting given based on the present noise characteristic, thereby further improving the recognition accuracy of the trigger command 6.

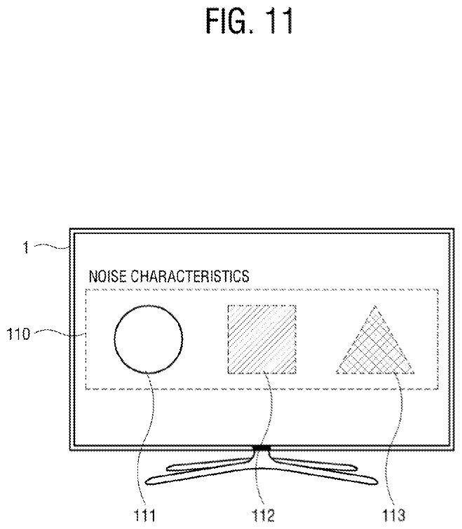

FIG. 11 shows a user interface showing noise characteristic, according to an embodiment.

As shown in FIG. 11, the processor 5 may display a user interface (UI) 110 showing a noise characteristic. The UI 110 may be displayed corresponding to the point in time of receiving or recognizing the second audio signal 7. For example, when the second audio signal 7 is received or recognized through the microphone 16, the UI 110 may be displayed.

Alternatively, the UI 110 may be displayed corresponding to the user 2. For example, when the user 2 approaches the electronic apparatus 1, the processor 5 identifies that the user 2 approaches the electronic apparatus 1 to utter an audio 3 for activating the speech recognition function and displays the UI 110.

The identification of the user 2 or the identification of whether the user 2 is approaching may be based on information obtained by the sensor 15. For example, the processor 5 controls the sensor 15 to capture a front of the electronic apparatus 1, thereby identifying the user 2 or identifying whether the user 2 is approaching, based on the image captured by the sensor 15.

The UIs 110 corresponding to the noise characteristics are displayed to be distinguished from each other. For example, when the noise characteristic corresponds little noise, a circle icon 111 may be displayed. On the other hand, when the noise characteristic corresponds to much noise, a square icon 112 may be displayed. In the case of much noise, the noise characteristic is further subdivided. More noise may be represented as a triangle icon 113. When the noise characteristic is continuously changed, the UI 110 may also be continuously changed and displayed. However, without limitations, the kind, shape, color, size, etc. of the UI 110 corresponding to the noise characteristic may be variously set according to designing methods.

When the noise characteristic is displayed as little noise through the UI 110, the user 2 may determine that the present noise environment of the surroundings is silent. In this case, the user 2 may utter the audio 3 for activating the speech recognition function with a small voice. On the other hand, when the noise characteristic is displayed as much noise, the user 2 may determine the present noise environment of the surroundings is noisy, and utter the audio 3 for activating the speech recognition function with a loud voice. Alternatively, a sound source causing the present noise environment of the surroundings to be noisy may be removed.

In this way, the processor 5 may display the UI 110 showing the noise characteristic, and allow the user 2 to utter the audio 3 adapted to the present noise environment or to develop a present noise environment suitable for the utterance of the audio 3.

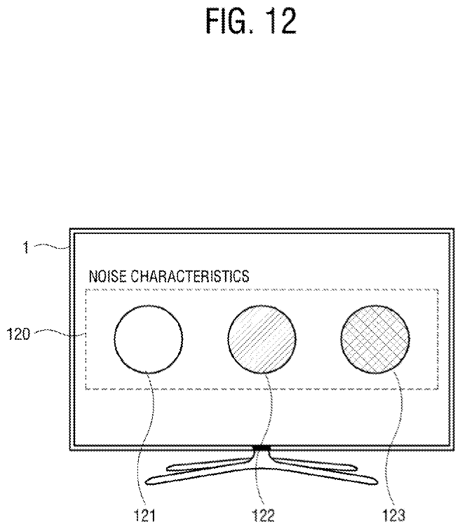

FIG. 12 shows the user interface of FIG. 11 displaying with different colors according to the noise characteristics, according to an embodiment.

The processor 5 may display the UI 110 showing a noise characteristic as described above with reference to FIG. 11, and a UI 120 may be displayed being varied in color depending on the noise characteristics as shown in FIG. 12. For example, when the noise characteristic is a small amount noise, a white circle icon 121 may be displayed. On the other hand, a gray circle icon 122 may be displayed when the noise characteristic is a medium amount noise, and a black circle icon 123 may be displayed for a large amount of noise.

When the noise characteristic is displayed as a small amount of noise through the UI 120, the user 2 may determine that the present noise environment of the surroundings is silent and utter the audio 3 for activating the speech recognition function with a small voice. On the other hand, when the noise characteristic is displayed as much noise, the user 2 may determine that the present noise environment of the surroundings is noisy and utter the audio 3 for activating the speech recognition function with a loud voice. Alternatively, a sound source causing the present noise environment of the surroundings to be noisy may be removed.

In this way, the processor 5 may display the UI 120 varied in color according to the noise characteristics, and allow the user 2 to intuitively recognize the present noise environment, thereby guiding the user 2 to utter the audio 3 adapted to the present noise environment or develop a present noise environment suitable for the utterance of the audio 3.

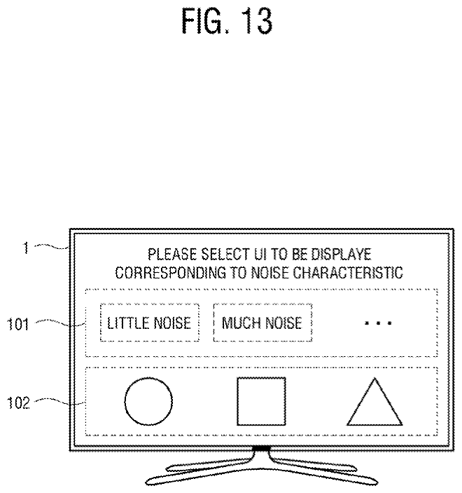

FIG. 13 shows the user interface of FIG. 11 which has been set based on a user input, according to an embodiment.

The processor 5 may set the UI 110, which has been described with reference to FIG. 11, based on a user input. To this end, the processor 5 may display a setting UI. For example, the processor 5 may display the setting UI including a first UI 101 showing various kinds of noise characteristics such as little nose, much noise, etc., and a second UI 102 showing icons different in shape from one another.

For convenience of description, it will be assumed that the user 2 assigns a square icon to little noise. When it is identified that the noise characteristic is little noise, the processor 5 displays the square icon through the UI 110. On the other hand, in a case where the user 2 assigns a circle icon to much noise, the processor 5 may display the circle icon through the UI 110 when the noise characteristic is identified as much noise.

Alternatively, the processor 5 may set the UI 120, which has been escribed with reference to FIG. 12, based on a user input. For example, in a case where the user 2 assigns a white circle icon to little noise, the processor 5 may display the white circle icon through the UI 120 when the noise characteristic is identified as little noise.

Alternatively, the processor 5 may set whether to display the UI 110 of FIG. 11 or the UI 120 of FIG. 12, based on a user. For example, the processor 5 may display a UI for settings about displaying, and display the UI 110 of FIG. 11 or the UI 120 of FIG. 12 based on the identified noise characteristic only in case where the displaying is allowed based on a user input.

In this way, the processor 5 allows the UI 110, which shows a present noise characteristic based on a user input through the setting UI, to be voluntarily set, so that the UI 110 can be displayed suitably for a user's taste. Therefore, user convenience is further improved.

Various embodiments may be achieved by software including one or more commands stored in a storage medium readable by the electronic apparatus 1 and the like (machine). For example, the processor 5 of the electronic apparatus 1 may call and execute at least one command among one or more stored commands from the storage medium. This enables the electronic apparatus 1 and the like apparatus to operate and perform at least one function based on the at least one called command. The one or more commands includes a code produced by a compiler or a code executable by an interpreter. The machine-readable storage medium may be provided in the form of a non-transitory storage medium. Here, the ‘non-transitory’ merely means that the storage medium is a tangible device and does not include a signal (for example, an electromagnetic wave), and this term does not distinguish between cases of being semi-permanently and temporarily stored in the storage medium. For instance, the ‘non-transitory storage medium’ may include a buffer in which data is temporarily stored.

For example, the method according to various embodiments may be provided as involved in a computer program product. The computer program product may include instructions of software to be executed by the processor as mentioned above. The computer program product may be traded as a commodity between a seller and a buyer. The computer program product may be distributed in the form of a machine-readable storage medium (for example, a compact disc read only memory (CD-ROM)) or may be directly or online distributed (for example, downloaded or uploaded) between two user apparatuses (for example, smartphones) through an application store (for example, Play Store™). In the case of the online distribution, at least a part of the computer program product (e.g., a downloadable app) may be transitorily stored or temporarily produced in a machine-readable storage medium such as a memory of a manufacturer server, an application-store server, or a relay server.

Although a few embodiments have been shown and described, it will be appreciated by those skilled in the art that changes may be made in these embodiments without departing from the principles and spirit of the invention, the scope of which is defined in the appended claims and their equivalents.

What is claimed is:

1. An electronic apparatus comprising:
a processor configured to:
identify a noise characteristic based on a first audio signal received through a microphone,
identify whether a second audio signal received through the microphone has a predetermined similarity level to a trigger command based on reference data, the reference data being selected from among pieces of reference data having a plurality of noise characteristics, respectively, and the selected reference data having a noise characteristic corresponding to the identified noise characteristic, and
perform an operation corresponding to a user speech input based on a third audio signal received after the second audio signal having the predetermined similarity level.

2. The electronic apparatus according to claim 1, wherein the processor is further configured to identify the noise characteristic based on the first audio signal received before a point in time of receiving the second audio signal.

3. The electronic apparatus according to claim 1, wherein the processor is further configured to adjust a time section, in which the first audio signal is received, based on a magnitude of the identified noise characteristic.

4. The electronic apparatus according to claim 1, wherein the processor is further configured to identify reference data having two or more noise characteristics corresponding to noise characteristics identified in two or more time sections identified in order of frame among the plurality of noise characteristics.

5. The electronic apparatus according to claim 4, wherein the processor is further configured to assign a high weighting to reference data having a noise characteristic corresponding to a noise characteristic identified in a time section nearer to a point in time of receiving the second audio signal among the two or more noise characteristics.

6. The electronic apparatus according to claim 5, wherein the processor is further configured to:
identify a first noise characteristic of reference data, which has a similarity with a frequency pattern of the second audio signal that is higher than or equal to a first preset value, among the two or more noise characteristics, and
modify the second audio signal using the reference data having the first noise characteristic, based on the identified first noise characteristic matching the noise characteristic of the reference data to which the high weighting is assigned.

7. The electronic apparatus according to claim 6, wherein the processor is further configured to modify the second audio signal based on reference data having a second noise characteristic, which has a similarity with the frequency pattern of the second audio signal that is higher than or equal to a second preset value higher than the first preset value, among the two or more noise characteristics, based on the identified first noise characteristic mismatching the noise characteristic of the reference data to which the high weighting is assigned.

8. The electronic apparatus according to claim 1, wherein the processor is further configured to:
identify the plurality of noise characteristics; and
provide a user interface to display the plurality of identified noise characteristics.

9. The electronic apparatus according to claim 8, wherein the processor is further configured to provide the user interface such that the identified plurality of noise characteristics are distinguished from each other according to strength or kinds of the identified noise characteristics.

10. A method of controlling an electronic apparatus, the method comprising:
identifying a noise characteristic based on a received first audio signal;
identifying whether a received second audio signal has a predetermined similarity level to a trigger command based on reference data, the reference data being selected from among pieces of reference data having a plurality of noise characteristics, respectively, and the selected reference data having a noise characteristic corresponding to the identified noise characteristic; and
performing an operation corresponding to a user speech input based on a third audio signal received after the second audio signal having the predetermined similarity level.

11. The method according to claim 10, wherein the identifying the noise characteristic comprises identifying the noise characteristic based on the first audio signal received before a point in time of receiving the second audio signal.

12. The method according to claim 10, wherein the identifying the noise characteristic comprises adjusting a time section, in which the first audio signal is received, based on a magnitude of the identified noise characteristic.

13. The method according to claim 10, further comprising: identifying reference data having two or more noise characteristics corresponding to noise characteristics identified in two or more time sections identified in order of frame among the plurality of noise characteristics.

14. The method according to claim 13, further comprising: assigning a high weighting to reference data having a noise characteristic corresponding to a noise characteristic identified in a time section nearer to a point in time of receiving the second audio signal among the two or more noise characteristics.

15. A recording medium with a computer program comprising a code, which performs a method of controlling an electronic apparatus, as a computer-readable code, the method comprising:
identifying a noise characteristic based on a received first audio signal;
identifying whether a received second audio signal has a predetermined similarity level to a trigger command based on reference data, the reference data being selected from among pieces of reference data having a plurality of noise characteristics, respectively, and the selected reference data having a noise characteristic corresponding to the identified noise characteristic; and
performing an operation corresponding to a user speech input based on a third audio signal received after the second audio signal having the predetermined similarity level.
